(19) United States
(12) Patent Application Publication
(10) Pub. No.: US 2012/0200272 A1
(43) Pub. Date: Aug. 9, 2012

(54) SHUNT REGULATOR FOR HIGH VOLTAGE OUTPUT USING INDIRECT OUTPUT VOLTAGE SENSING

(75) Inventors: Andrew Paul Le Fevre, Dumnow (GB); Neil E. Robinson, Ayot St Lawrence (GB)

(73) Assignee: INTERSIL AMERICAS INC., Milpitas, CA (US)

(21) Appl. No.: 13/332,933

(22) Filed: Dec. 21, 2011

Related U.S. Application Data
(60) Provisional application No. 61/535,335, filed on Sep. 15, 2011.
(60) Provisional application No. 61/469,185, filed on Mar. 30, 2011.
(60) Provisional application No. 61/440,230, filed on Feb. 7, 2011.

(51) Int. Cl. G05F 1/10

(52) U.S. Cl. 323/265

(57) ABSTRACT

Embodiments disclosed herein provide for a voltage regulator having one or more Zener diodes coupled in series between an output voltage and system ground. The one or more Zener diodes are in a reverse biased configuration. A transistor is coupled in series with the one or more Zener diodes between the one or more Zener diodes and system ground. A control circuit is coupled to the transistor and configured to adjust the transistor to control a voltage level of the output voltage. The control circuit is configured such that transistor is adjusted substantially independent of values of the one or more Zener diodes.

### CROSS-REFERENCE TO RELATED APPLICATIONS

This application claims the benefit of priority to U.S. Provisional Application No. 61/440,230, filed on Feb. 7, 2011, U.S. Provisional Application No. 61/469,185 filed on Mar. 30, 2011, and U.S. Provisional Application No. 61/535,335 filed on Sep. 15, 2011, all of which are hereby incorporated herein by reference.

### BRIEF DESCRIPTION OF THE DRAWINGS

The numerous aspects, embodiments, objects and advantages of the present invention will be apparent upon consideration of the following detailed description, taken in conjunction with the accompanying drawings, in which like reference characters refer to like parts throughout.

FIG. 1 illustrates a high-level functional block diagram of an example of an integrated circuit having a charge pump with an output voltage regulated by a shunt regulator having a low voltage control.

FIG. 2 illustrates a schematic block diagram of an example of the shunt regulator of FIG. 1.

FIG. 3 illustrates a circuit diagram of an example of the shunt regulator of FIG. 1.

FIG. 4 illustrates a circuit diagram of an example voltage regulation indicator circuit that can be used with the shunt regulator of FIG. 3

FIG. 5 illustrates a circuit diagram of another example of the shunt regulator of FIG. 1, wherein the shunt regulator has a current mirror to produce a load independent reference current.

FIG. 6 is a block diagram of an example of an electronic device including the charge pump and shunt regulator of FIG. 1.

### DETAILED DESCRIPTION

Embodiments of the subject innovation can reduce cost for a high voltage regulated on chip charge pump. Embodiments of the subject innovation can employ a string of Zener diodes in a shunt regulator configuration with a low voltage control circuit to regulate a high voltage output.

The subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the subject matter may be practiced without these specific details. In other instances, well-known structures and devices are shown in block diagram form in order to facilitate describing the subject innovation.

Moreover, the word “example” is used herein to mean serving as an example, instance, or illustration. Any aspect or design described herein as an “example” is not necessarily to be construed as preferred or advantageous over other aspects or designs. Rather, use of the word “example” is intended to present concepts in a concrete fashion. In addition, the word “coupled” is used herein to mean direct or indirect electrical or mechanical coupling.

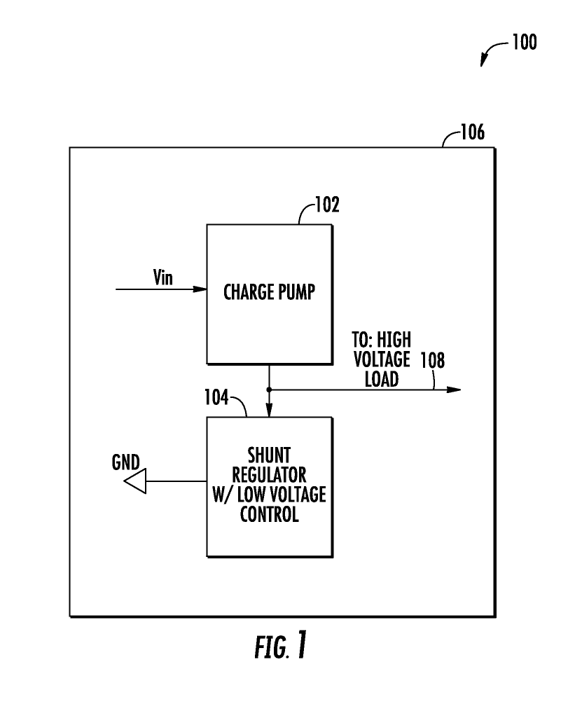

Referring to FIG. 1, there illustrated is an example system 100 for implementing a high voltage regulated charge pump 102 and shunt regulator 104 according to an aspect of the subject disclosure. In an example, the charge pump 102 and the shunt regulator 104 are disposed on an integrated circuit (IC) chip 106. In other examples, the charge pump 102 and the shunt regulator 104 can be composed of discrete components and/or multiple ICs.

The shunt regulator 104 of system 100 employs a string of Zener diodes (e.g., three Zener diodes) to shunt excess current from the charge pump 102 in order to regulate a high output voltage, Vout, at output 108. Shunt regulator 104 can generate the high output voltage at output 108 utilizing the string of Zener diodes (e.g., three Zener diode clamps). In an example, the high output voltage at output 108 can be at least 10 V. In another example, the high output voltage at output 108 can be at least 15 volts. In a further example, the high output voltage at output 108 can be at least 18 V or any desired high voltage value.

The string of Zener diodes utilized in the shunt regulator 104 can occupy a comparatively smaller area on the IC chip 106 than traditional regulators. According to an embodiment, the total area on the IC chip 106 taken up by the string of Zener diodes can be at least five to thirteen times smaller than the area utilized in existing regulators since some examples of the shunt regulator 104 does not use the large feedback resistors used by traditional regulators.

In operation, the charge pump 102 can receive a voltage at an input, Vin, and generate an output voltage, Vout, at output 108. The shunt regulator 104 can be coupled to the output 108 and can regulate the output voltage, Vout, to within a desired voltage range. In particular, the shunt regulator 104 can attempt to regulate the output voltage, Vout, given variations in the power provided by the charge pump 102 as well as variations in the load. The shunt regulator 104 can provide this voltage regulation while using a control circuit that operates at a lower voltage than the output voltage, Vout. More detail regarding the shunt regulator 104 is provided below.

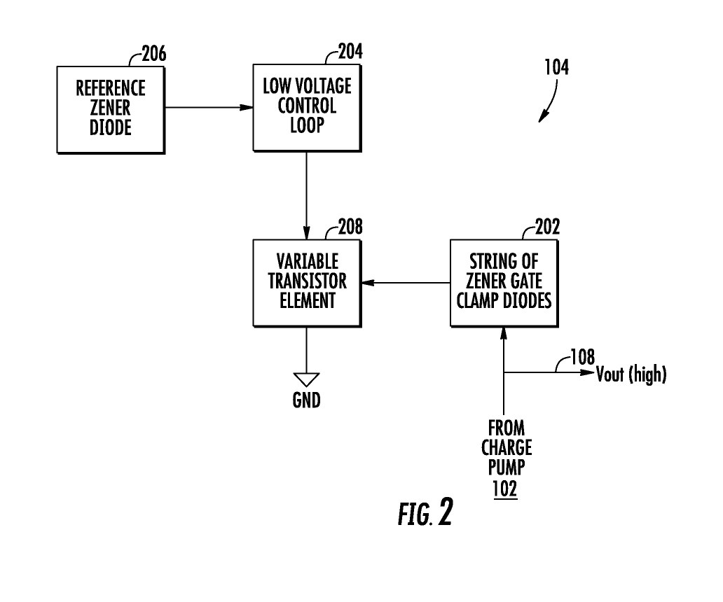

Referring now to FIG. 2, illustrated is a schematic block diagram of one embodiment of shunt regulator 104 of FIG. 1. The shunt regulator 104 can include a string of (i.e., series coupled) Zener diodes 202, a control circuit 204 (e.g., a low voltage amplifier loop), a reference Zener diode 206, and a transistor 208.

The string of Zener diodes 202 can be coupled to an output 108. The string of Zener diodes 202 can be couple in series with one another and in series with the transistor 208. In particular, the string of Zener diodes 202 and the transistor 208 can be coupled in series between the output 108 and system ground (e.g., 0v, earth ground). The transistor 208 can be controlled by the control circuit 204. The control circuit 204 can control the transistor 208 based in part on a reference voltage (Vz) obtain from the reference Zener diode 206.

In operation, the transistor 208 and the Zener diodes 202 can regulate the output voltage Vout at output 108 by drawing excess current to system ground. The low voltage control circuit 204 can control the transistor 208 such that when excess current is present at the output 108 (e.g., when the charge pump 102 is over-regulated, that is when the charge pump 102 is providing more current than used by the load), the transistor 208 is adjusted to draw additional current from the output 108; thereby reducing rise in the output voltage Vout at output 108. Conversely, the low voltage control circuit 204 can control the transistor 208 such that when insufficient current is present at the output 108 (e.g., when the charge pump 102 is under-regulated, that is when the load and the shunt regulator 104 are drawing more current than provided by the charge pump 102), the transistor 208 is adjusted to draw less current from the output 108; thereby reducing a drop in the output voltage Vout at 108. The low voltage control circuit 204 can use a voltage drop across the reference Zener diode 206 as a reference voltage. In an example, the reference Zener diode 206 can be configured to have substantially matching characteristics to the string of Zener diodes 202. In an example, the shunt regulator 104 can be fabricated on a monolithic integrated circuit to enable excellent characteristic (e.g., current-voltage curve) matching for the reference Zener diode 206 and the string of Zener diodes 202.

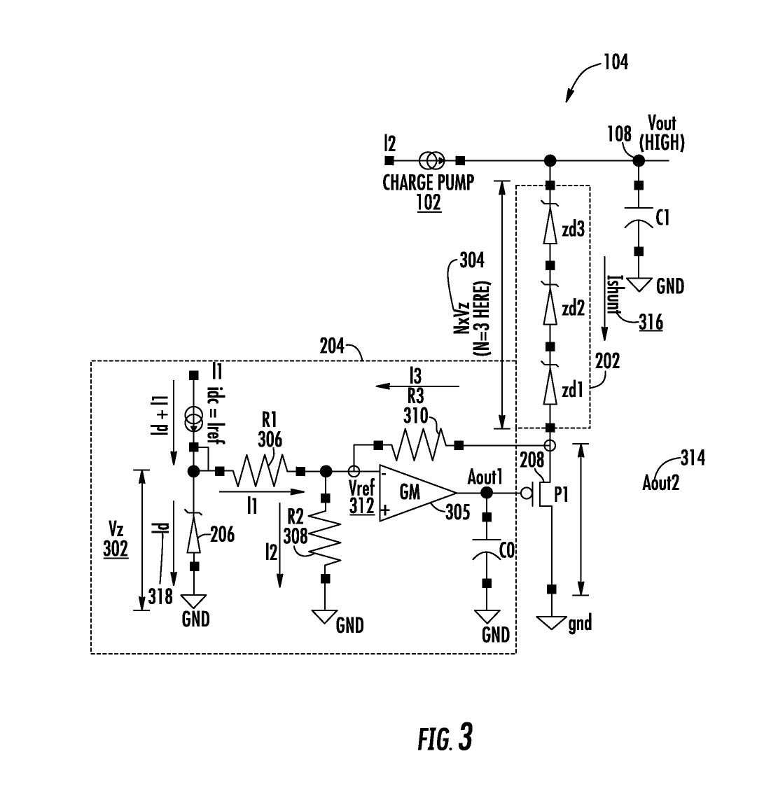

FIG. 3 is a circuit diagram of an example of the shunt regulator 104. The shunt regulator 104 can include the string of Zener diodes 202, the control circuit 204, the reference Zener diode 206, and the transistor 208 illustrated in FIG. 2. As shown, the string of Zener diodes 202 are coupled between the output voltage 108 and system ground in a reverse biased configuration. That is, the Zener diodes 202 can be coupled such that a cathode is toward the output voltage 108 and an anode is toward system ground. Since the Zener diodes 202 are coupled in series, the Zener diodes 202 will conduct when the voltage drop across the Zener diodes 202 (N×Vz 304) is at or above the sum of the Zener voltage (Vz) of each diode 202. That is, a number N of Zener diodes 202 will conduct when the voltage drop is equal to or greater than N×Vz. In an example, the Zener voltage for the diodes 202 is 5v such that the voltage drop across the string of Zener diodes 202 in FIG. 3 is 15v.

The transistor 208 is coupled in series with the string of Zener diodes 202 between the Zener diodes 202 and system ground. This series of the string of Zener diodes 202 and the transistor 208 can be referred to as the “shunt current path”. The shunt current path will conduct (i.e., draw down current from the output voltage 108) when the output voltage, Vout, is larger than the Zener voltage drop across the Zener diodes 202 and when the transistor 208 is in a conduction mode. The transistor 208 is controlled to draw current from the output voltage, Vout, during over-regulated periods. The output voltage, Vout, is regulated at a voltage N×Vz2+Aout2 (314), where Aout2 is less than Vz.

The shunt regulator 104 can help in the generation of a high voltage output 108 when there is limited output current capability (e.g., due to small pump capacitors in the charge pump 102), since current is not drawn from the output voltage, Vout, when under regulated. This can be advantageous over circuits that sense the output voltage, Vout, directly with a resistor chain.

The reference Zener diode 206 can have a corresponding Zener voltage (Vz) 302. As an approximation, each Zener diode in the string of Zener diodes 202 can also have a Zener voltage Vz. The voltage across the string of Zener diodes 202 can be equal to the number of Zener diodes in the shunt (N) times Vz, or NVz. In an embodiment, Vz can be 5 V. When N is 3, the voltage across the string of Zener diodes 202 can be 15 V.

When the high output voltage, Vout, is under regulated, no current is drawn from the output 108. This can enable the charge pump 102 to provide most or all of its output current to the load during high load periods. When the charge pump 102 rises to the regulation voltage (e.g., by a reduction in load draw), the string of Zener gate diodes 202 and the control circuit 204 can regulate the high output voltage, Vout, by shunting excess current to system ground.

Although the string of Zener diodes 202 includes three Zener diodes (zd1, zd2 and zd3), the string of Zener diodes 202 can include any number of Zener diodes. The string of Zener diodes 202 and the reference Zener diode 206 can be replaced with any suitable well matching voltage drop element, e.g., a diode VBE, a resistor, or a Shottky diode. In a shunt regulator path configuration, this eliminates the need for direct output voltage sensing and also eliminates the need for high value resistors, which may be difficult and/or costly to implement within integrated circuits.

In an example, the control circuit 204 can include a differential amplifier 305, a feedback network including a plurality of resistors 306, 308, 310, and a reference Zener diode 206. The differential amplifier 305 can have an output that is coupled to a control input of the transistor 208. For example, if the transistor 208 is a field effect transistor (FET), the output of the differential amplifier 305 can be coupled to a gate of the FET. To control the output of the differential amplifier 305, the feedback network (e.g., resistors 306, 308, 310) can be coupled to either or both the non-inverting input and inverting input of the differential amplifier 305. In an example, the feedback network includes a first resistor 306 coupled between the inverting input and a Zener voltage (Vz) provided by the reference Zener diode 206. The reference Zener diode 206 can be coupled in a reverse biased configuration such that a cathode is coupled to the first resistor 306 and an anode is coupled to system ground. The feedback network can also include a second resistor 308 coupled between the inverting input and system ground, and a third resistor 310 coupled between an inverting input and a point between the one or more Zener diodes 202 and the transistor 208. The non-inverting input of the differential amplifier 305 can be coupled to a reference voltage Vref 312.

In this configuration, the high output voltage, Vout, can be determined based on the value of resistors R1 306, R2 308 and R3 310, the value of Vref 312, N×Vz 304, and Vz 302. The high output voltage, Vout, can be determined according to Equation (1):

Vout=Vref(R3/R2+R3/R1+1)−VzR3/R1+NVz (1).

Accordingly, the output voltage 108 can be controlled based on the reference voltage, Vref, 312 at the non-inverting input of the differential amplifier 305. In particular, the control circuit 204 can compare the reference voltage, Vref, 312 to a low voltage at the point between the one or more Zener diodes 202 and the transistor 208. When the voltage at the point between the one or more Zener diodes 202 and the transistor 208 is too high with respect to the reference voltage, Vref, 312, the control circuit 204 can draw additional current from the high output voltage, Vout, by adjusting the transistor 208. When the voltage at the point between the one or more Zener diodes 202 and the transistor 208 is too low with respect to the reference voltage Vref 312, the control circuit 204 can draw less current from the high output voltage, Vout, by adjusting the transistor 208. Additionally, as shown by Equation 1, process variability (e.g., the value) of the Zener diode 302 can be cancelled when R3/R1=N due to the summing configuration of the control circuit 204. That is, in an example, the reference Zener diode 206 can be selected to have the same characteristics (e.g., current-voltage curve) as the one or more Zener diodes 202 and the value of the third resistor R3 310 divided by the value of the first resistor R1 306 can be set to the number of Zener diodes in the one more Zener diodes 202. In the example shown in FIG. 3, R3/R1 would be set to 3.

According to an example, the low voltage, Aout2, 314 can be any desired fractional value of Vz such that the high output voltage, Vout, can equal NVz+Aout2 and can take on any desired value. When N×Vz=R3/R1 all variation of Vz is cancelled and the high voltage output, Vout, depends the value of the reference voltage, Vref, 312 and on the ratios of resistors 306, 308, 310, which are very well matched, and not on the value of the Zener diodes 202.

In practice, it may be necessary to adjust the size of the N Zener diodes in the string of Zener diodes 202 to reduce a corresponding resistive slope resistance if the shunt current (Ishunt 316) is much greater than the reference current, Id, 318, the reference diode current, in order to maintain the accuracy of the output voltage, Vout, over large changes of the shunt current, Ishunt, 316. Accuracy of the output voltage, Vout, depends to a first order on the reference voltage, Vref, 312, the matching of the resistors R1 306, R2 308 and R3 308 of the control circuit 204, and the slope resistance of the Zener diodes 202.

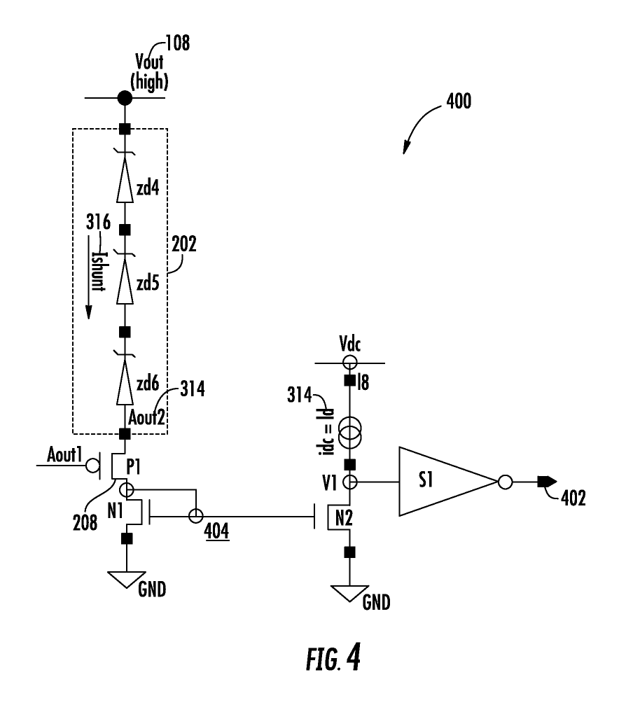

Referring now to FIG. 4, illustrated is an example circuit 400 that can provide a voltage regulation indication signal for the shunt regulator 104. Circuit 400 can output the voltage regulation indication signal (e.g., an in-regulation signal) to indicate the output voltage, Vout, at the output 108 is at or above the desired voltage. In an example, a load can be configured to receive the voltage regulation indication signal as an indication that the shunt regulator 104 is regulating the output voltage, Vout, and that the output voltage, Vout, is at (or above) the desired voltage. Thus, any components and/or circuits (such as an on-chip read-only memory, such as an electrically erasable programmable read only memory (EEPROM), which must have a known supply voltage in order to successfully carry out cycles, such as ERASE or WRITE) that utilize the regulated supply to know when regulation is achieved.

According to an embodiment, the voltage regulation indication signal can be generated by comparing the current through the one or more Zener diodes 202 to a reference current that can indicate that the output voltage, Vout, has reached the regulation voltage. When the current through the one or more Zener diodes exceeds the reference current, the voltage regulation indication signal can be utilized, for example, to allow any circuits that use the regulated supply to know when regulation is achieved. The voltage regulation indication signal can allow any circuit to sense when an output is in regulation without having to directly observe and/or monitor the output voltage, Vout, directly.

Circuit 400 can include a current mirror 404. The current mirror 404 can be a semiconductor field effect transistor (e.g., a MOSFET) 1:1 N1/N2 current mirror. N1, N2 and I8 facilitate detection of when the shunt current, Ishunt, 316 (the current through the string of Zener diodes 202) is greater than the reference current, Id, 318 (the current set up in the reference Zener diode 206, shown in FIGS. 2 and 3). When Ishunt 316 is greater than Id 318, the output voltage, Vout, at output 108 has reached its required regulation voltage. To alert components and/or circuits that utilize the output voltage, Vout, the voltage regulation indication signal can be provided from output 402 (Vout_ok). The voltage regulation indication signal can be high when Ishunt 316 is greater than Id 318 and Vout has reached its regulated high voltage. For example, the voltage regulation indication signal indicating that Vout is in regulation can be a Vdc supply rail related voltage.

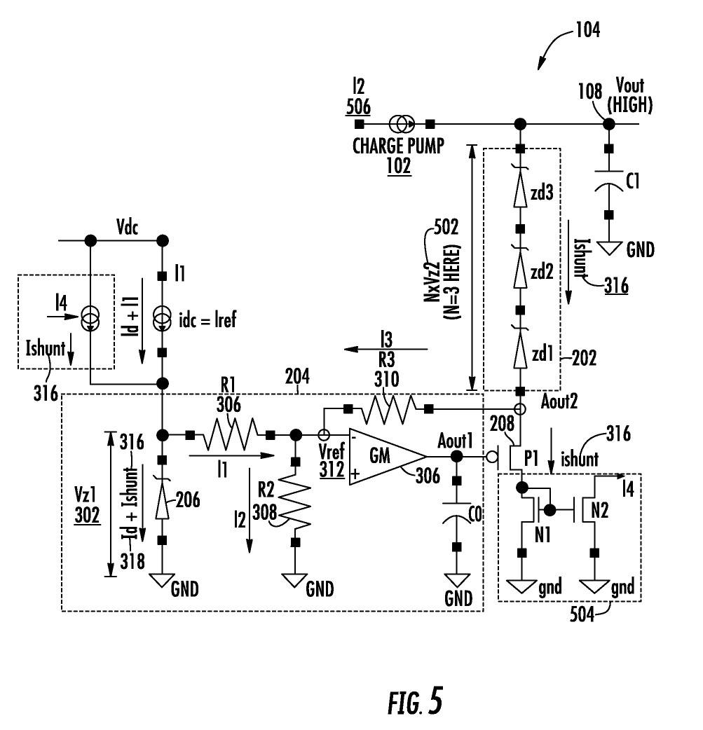

Referring now to FIG. 5, illustrated is another example configuration of shunt regulator 104. The circuit illustrated in FIG. 5 can provide high voltage regulation while ensuring that the output voltage at output 108 is independent of the shunt current (Ishunt) flowing through the one or more Zener diodes 202 and the slope resistance (Rslope) of the one or more Zener diodes 202. To accomplish this, a corrected reference current can be provided to the reference Zener diode 206. The corrected reference current can be based on a mirror of the shunt current, Ishunt, 316 flowing through the string of Zener diodes 202.

The reference current, Id, 318 is a low reference current used for the reference diode 206 when the Ishunt 316 load is ˜Id 318. For Ishunt 316>>Id 318, a corrected reference current can be used. The corrected reference current can include adding Ishunt 316 to Id 318 so that the slope resistance of both the one or more Zener diodes 202 and the reference Zener diode 206 are more closely matched. This can eliminate the dependence of the output voltage, Vout, on the shunt current, Ishunt, 316 and the slope resistance of the string of Zener diodes 202 that form the shunt.

As described above, the output voltage, Vout for the circuit of FIG. 3 can be determined according to Equation (1). In Equation (1), an approximation was made that the voltage 302 across the reference Zener diode 206 is approximately equal to the voltage 304 across each of the shunt Zener diodes 202. However, in practice, this approximation is not always the case. One instance where the approximation does not hold is when Ishunt 316 is much greater than Id 318.

The circuit of FIG. 5 can address this concern and accurately determine the output voltage, Vout. The output voltage, Vout, for the circuit of FIG. 5 can be found via Equation (2):

Vout=Vref(R3/R2+R3/R1+1)−Vz1(R3/R1)+NVz2 (2)

In practice, the voltage across a Zener diode depends on the slope resistance of the Zener diode. More accurately, the voltage, Vz1, 302 across the reference Zener diode 206 of FIG. 5 can be expressed as depending on the correct reference current (Id 318+Ishunt 316) and the effective slope resistance (Rslope) of the reference Zener diode 206. The current, Id, 318 is a constant current. The effective slope resistance of the reference Zener diode 206 is an effective slope resistance of Zener diodes of the same size. The voltage 302 (Vz1) across the reference Zener diode 206 is shown in Equation (4):

Vz1=Vz+(Id+Ishunt)Rslope (4)

Similarly, the voltage, Vz2, 502 across each of the Zener diodes in the string of Zener diodes 202 (illustrated in FIG. 5, N=3: zd1, zd2, zd3) depends on the shunt regulation current, Ishunt, 316 and the effective slope resistance (Rslope) of each of the Zener diodes (zd1, zd2, zd3) in the string of Zener diodes 202. The shunt regulation current, Ishunt, 316 is variable (e.g., it can increase). The effective slope resistance (Rslope) of each Zener diode in the string if Zener diodes 202 is an effective slope resistance of Zener diodes of the same size. The voltage, Vz2, 502 across each of the Zener diodes 202 (zd1, zd2, zd3) is shown in Equation (5):

Vz2=Vz+IshuntRslope (5)

Replacing Vz1 with Equation (4) and Vz2 with Equation (5), Equation (2) becomes:

Vout=Vref(R3/R2+R3/R1+1)−(Vz+(Id+Ishunt)Rslope)(R3/R1)+N(Vz+IshuntRslope) (6)

Without the shunt current, Ishunt, 316, the term (Id+Ishunt)Rslope may not be close enough to IshuntRslope and the voltage, Vz1, 302 across the reference Zener diode 206, therefore, may not be equal to the voltage, Vz2, 502 across the string of Zener diodes 202. Therefore, the Vz1 302 and Vz2 502 terms would not cancel each other out when R3 310/R1 306=N.

It is apparent in Equation (6) that by adding Ishunt 316 to Id 318, when Ishunt 316>>Id 318 the corrected reference current can be made approximately equal to Ishunt 316, and Vz1 302 and Vz2 502 can cancel when R3 310/R1 306=N. Thus, the accuracy of Vout 108 will only depend on the reference voltage, Vref, 312 and the resistor ratios involving R1 306, R2 308 and R3 310.

The circuit illustrated in FIG. 5 can achieve an output voltage, Vout, which depends only on the reference voltage, Vref, 312, and the ratios involving R1 306, R2 308 and R3 310 by ensuring that the corrected reference current is made approximately equal to Ishunt 316. First, a shunt current (Ishunt) is detected and copied to a source. For example, the shunt current (Ishunt) can be sensed flowing through a drain of the transistor 208. As shown, this can be accomplished via a current mirror 504. The current mirror 504 can be an nMOS (n-type metal-oxide-semiconductor field-effect transistor) that can act as a current mirror (N1 and N2) to sense the shunt current, Ishunt, 316 flowing through drain P1. The shunt current, Ishunt, 316 can be reflected up to a similar pMOS (p-type metal-oxide-semiconductor field-effect transistor) current mirror on the power supply (e.g., a VDC supply, shown in FIG. 5 as a current source, I2, 506). The corrected reference current (Ishunt 316+Id 318) can then be provided to the reference Zener diode 206. When Ishunt 316 is much greater than Id 318, the current flowing into the reference Zener diode 206 is approximately Ishunt 316, and when R3 310/R1 306=N, Equation (6) simplifies to:

Vout=Vref(R3/R2+R3/R1+1) (7)

where Vout is independent of the shunt current (Ishunt) and the slope resistance (Rslope) of the Zener diodes 202.

This allows the cancellation of dependence of the output voltage (Vout) 108 on the shunt current (Ishunt 316) and Rslope resistance of 202 and 206. Although a system utilizing nMOS and pMOS system are illustrated in FIG. 5, any type of circuit that can copy Ishunt 316 into the reference Zener diode 206 is within the scope of this disclosure.

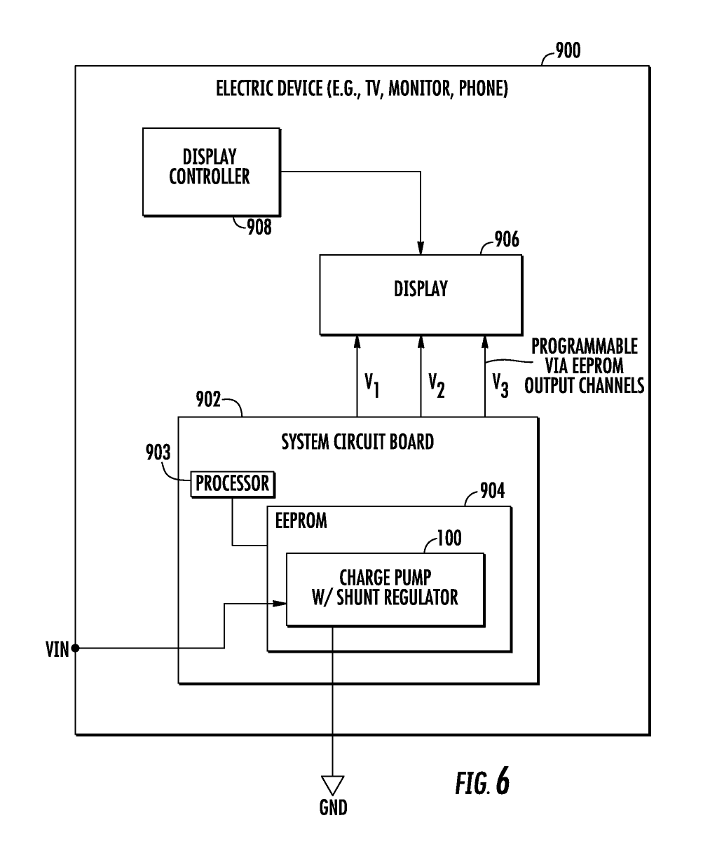

FIG. 6 is a block diagram of an example electronic device 900 including a charge pump and shunt regulator circuit 100. The electronic device 900 can be any suitable electronic device such as a TV, monitor, mobile phone, computer, tablet, laptop, or other device. The electronic device 900 can include a system circuit board 902 having a processor 903 and an electronically erasable memory (e.g., an EEPROM) 904 thereon. The electronically erasable memory 904 can be coupled the processor 902. The electronically erasable memory 904 can also be coupled to the charge pump and shunt regulator circuit 100. The charge pump and shunt regulator circuit 100 can be configured to receive an input voltage (Vin) and boost the input voltage up to a higher voltage for use by the electronically erasable memory 904. In an example, the charge pump and shunt regulator circuit 100 can provide a high output voltage for erasing the electronically erasable memory 904. The system circuit board 902 can be coupled to a display 906. The system circuit board 902 can be configured to provide output channels to the display 906 and the output channels can be programmable via the electronically erasable memory 904. The display 906 can be controlled by a display controller 908.

In operation, the output channels can be reprogrammed by causing the charge pump with shunt regulator circuit 100 to output a high voltage to the electronically erasable memory 904, thereby erasing the electronically erasable memory 904 such that the electronically erasable memory 904 can be re-programmed. The shunt regulator can regulate the output voltage such that the output voltage does not rise higher than is suitable for the electronically erasable memory 904.

It should be understood that the electronic device 900 illustrated in FIG. 6 is merely an example, and the charge pump with shunt regulator circuit 100 can be used in other electronic devices.

What has been described above are various embodiments of the subject innovation. While a particular feature of an embodiment may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

The components and circuitry elements described above can be of any suitable value in order to implement an embodiment of the subject innovation. For example, the resistors can be of any suitable resistance, amplifiers can provide any suitable gain, current sources can provide any suitable amperage, etc. The resistors and capacitors can be of any suitable value and/or have any particular ratios between one another. Further, the amplifiers can include any suitable gain.

It is, of course, not possible to describe every conceivable combination of components or acts for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims.

What is claimed is:

1. A voltage regulator comprising:
one or more Zener diodes coupled in series between an output and system ground, the one or more Zener diodes coupled such that a cathode is toward the output voltage and an anode is toward system ground;
a transistor coupled in series with the one or more Zener diodes between the one or more Zener diodes and system ground; and
a control circuit coupled to the transistor and configured to adjust the transistor to control a voltage level of the output voltage, the control circuit including a reference Zener diode having substantially matching characteristics to the one or more Zener diodes, the control circuit configured such that transistor is adjusted substantially independent of values of the one or more Zener diodes.

2. The voltage regulator of claim 1, wherein the one or more Zener diodes comprise multiple Zener diodes coupled in series with one another.

3. The voltage regulator of claim 1, wherein the control circuit includes an amplifier loop.

4. The voltage regulator of claim 3, wherein the amplifier loop controls the transistor such that a voltage between the one or more Zener diodes and the transistor does not rise above a value based on a reference voltage.

5. The voltage regulator of claim 3, wherein the amplifier loop comprises:
a differential amplifier having an inverting input, a non-inverting input, and an output, the non-inverting input coupled to a reference voltage, and the output coupled to the transistor;
a first resistor coupled between the inverting input and the reference Zener diode;
a second resistor coupled between the inverting input and system ground; and
a third resistor coupled between the inverting input and a point between the one or more Zener diodes and the transistor.

6. The voltage regulator of claim 5, wherein the amplifier loop is configured such that a value of the first resistor divided by the third resistor is equal to the number of Zener diodes in the one or more Zener diodes.

7. The voltage regulator of claim 6, wherein the reference Zener diode is coupled between the first resistor and system ground such that a cathode is toward the first resistor and an anode is toward system ground, wherein a reference current flows through the reference Zener diode.

8. The voltage regulator of claim 7, comprising:
a current mirror configured to mirror a current through the one or more Zener diodes into the reference Zener diode.

9. The voltage regulator of claim 1, comprising:
a voltage regulation indicator circuit configured to compare a shunt current through the one or more Zener diodes with a second reference current, and when the current through the one or more Zener diodes is greater than the second reference current, output an indication that the output voltage is in regulation.

10. A method of regulating an output voltage, the method comprising:
outputting a voltage at a cathode of one or more Zener diodes in a reverse biased configuration based on an amplifier loop having a feedback network and a reference voltage, the one or more Zener diodes coupled in series between an output voltage and system ground;
if the voltage at the cathode of the one or more Zener diodes is higher than a value based the feedback network and the reference voltage, drawing additional current from the output voltage through the one or more Zener diodes; and
if the voltage at the cathode of the one or more Zener diodes is lower than the value, drawing less current from the output voltage through the one or more Zener diodes.

11. The method of claim 10, wherein the amplifier loop includes a differential amplifier having an inverting input, a non-inverting input, and an output, the non-inverting input coupled to the reference voltage, and the output coupled to a transistor;
wherein the feedback network includes:
a first resistor coupled between the inverting input and a reference Zener diode;
a second resistor coupled between the inverting input and system ground; and
a third resistor coupled between the inverting input and a point between the one or more Zener diodes and the transistor.

12. The method of claim 11, wherein the reference Zener diode is coupled between the first resistor and system ground such that a cathode is toward the first resistor and an anode is toward system ground, and the reference Zener diode has substantially matching characteristics to the one or more Zener diodes; and
wherein the amplifier loop is configured such that a value of the first resistor divided by the third resistor is equal to the number of Zener diodes in the one or more Zener diodes.

13. The method of claim 12, wherein drawing additional current includes drawing additional current when the output voltage is higher than the reference voltage multiplied by the third resistor over the second resistor plus the third resistor over the first resistor plus 1; and
wherein drawing less current includes drawing less current when the output voltage is lower than the reference voltage multiplied by the third resistor over the second resistor plus the third resistor over the first resistor plus 1.

14. The method of claim 11, comprising:
outputting a signal indicating that the output voltage is in regulation when a shunt current flowing through the one or more Zener diodes is greater than a current flowing through the reference Zener diode.

15. The method of claim 11, comprising:
mirroring a current through the one or more Zener diodes into the reference Zener diode.

16. An integrated circuit comprising:
a charge pump having an input to receive an input voltage and an output to provide an output voltage; and
a shunt regulator coupled to the output of the charge pump, the shunt regulator comprising:
one or more voltage drop elements coupled between the output of the charge pump and system ground;
a transistor coupled in series with the one or more voltage drop elements between the one or more voltage drop elements and system ground; and
an amplifier loop coupled to the transistor and configured to adjust the transistor to draw excess current to system ground in order to control the output voltage, the amplified loop including a reference voltage drop element having substantially matching characteristics to the one or more voltage drop elements, the control circuit configured such that the transistor is adjusted substantially independent of values of the one or more voltage drop elements.

17. The integrated circuit of claim 16, wherein the amplifier loop comprises:
a differential amplifier having an inverting input, a non-inverting input, and an output, the non-inverting input coupled to a reference voltage, and the output coupled to the transistor;
a first resister coupled between the inverting input and the reference voltage drop element;
a second resister coupled between the inverting input and system ground; and
a third resister coupled between the inverting input and a point between the one or more voltage drop elements and the transistor.

18. The integrated circuit of claim 17, wherein the amplifier loop is configured such that a value of the first resistor divided by the third resistor is equal to the number of voltage drop elements in the one or more voltage drop elements.

19. The integrated circuit of claim 16, wherein one or more voltage drop elements include one or more of: a resistor, a diode in a forward biased configuration, or a Zener diode in a reverse biased configuration.

20. An electronic device comprising:
a processor;
an electronically erasable memory coupled to the processing device; and
a regulated voltage converter configured to provide power to the electronically erasable memory, the regulated voltage converter including:
a charge pump having an input to receive an input voltage and an output to provide the power to the electronically erasable memory; and
a shunt regulator coupled to the output of the charge pump, the shunt regulator including:
one or more Zener diodes coupled in a reverse biased configuration between the output of the charge pump and system ground;
a transistor coupled in series with the one or more Zener diodes between the one or more Zener diodes and system ground;
a differential amplifier having an inverting input, a non-inverting input, and an output, the non-inverting input coupled to a reference voltage, and the output coupled to a gate of the transistor;
a reference Zener diode configured to have a reference current flowing therethrough and coupled in a reverse biased configuration; and
a feedback network coupled to the differential amplifier, the reference Zener diode, and a point between the one or more Zener diodes and the transistor, wherein the feedback network is configured such that the transistor is adjusted substantially independent of values of the one or more Zener diodes.

21. The electronic device of claim 20, wherein the feedback network includes:
a first resister coupled between the inverting input and the reference Zener diode;
a second resister coupled between the inverting input and system ground; and
a third resister coupled between the inverting input and a point between the one or more Zener diodes and the transistor.

22. The electronic device of claim 21, wherein the feedback network is configured such that a value of the first resistor divided by the third resistor is equal to the number of Zener diodes in the one or more Zener diodes.

23. The electronic device of claim 20, wherein the reference Zener diode that has a similar current-voltage curve to the one or more Zener diodes.
